(19) United States
(12) Patent Application Publication
(10) Pub. No.: US 2016/0224085 A1
(43) Pub. Date: Aug. 4, 2016

(54) DEVICE AND METHOD FOR CONTROLLING STATE IN ELECTRONIC APPARATUS INCLUDING COMPONENTS CAPABLE OF BEING WIRELESSLY CONNECTED

(71) Applicant: Samsung Electronics Co., Ltd., Suwon-si, Gyeonggi-do (KR)

(72) Inventors: Ohyun JO, Seoul (KR); Chang-Yeul KWON, Seongnam-si (KR); Dong-Hwi ROH, Seoul (KR)

(21) Appl. No.: 15/022,133

(22) PCT Filed: Sep. 15, 2014
(86) PCT No.: PCT/KR2014/008547

§ 371 Date: Mar. 15, 2016

(30) Foreign Application Priority Data
Sep. 16, 2013 (KR) 10-2013-0111149

(51) Int. Cl. G06F 1/26; G06F 1/32; H04W 4/00

(52) U.S. Cl. CPC G06F 1/266; H04W 4/005; G06F 1/3287

(57) ABSTRACT

The present invention relates to a power consumption adjustment in an electronic apparatus capable of wirelessly connecting components with each other, and an operation of a peripheral device includes the steps of: detecting whether a contact occurs in at least one predetermined point of the peripheral device; and supplying power to at least one module located in the peripheral device. In addition_{;} the present invention includes other embodiments excluding the above-mentioned embodiment.

### BACKGROUND OF THE INVENTION

1. Field of the Invention

The present invention relates to operation control in an electronic device including wirelessly connectable components.

2. Description of the Related Art

In modern society, electronic devices having various forms, objectives, and functions are used. In addition to widely used portable phone, personal computer, digitalized devices are used in various industrial fields. The electronic device even consists of one single component, but can consist of a combination of a plurality of components. For example, the personal computer consists of a body, a monitor, a keyboard, a mouse, etc. For another example, an ultrasonic inspector used in the medical field consists of observation equipment, which is named a probe, and a system body.

In case of an electronic device including a plurality of components, a connection for communication between the components is required. In case of the conventional art, the connection was mainly achieved in a wired form. However, according as wireless communication technologies are developed, a wireless connection between components was made possible. For example, in case of a personal computer, a wireless mouse, a wireless keyboard, etc. support the wireless connection.

In case of a wired connection, power can be continuously supplied to each component through the wire. Therefore, a degree of power consumption has no great influence. However, in case of a wireless connection, continuous power supply is difficult. That is, each component must have a separate power supply means such as a battery. As a result, each component is operated using a restricted capacity of power.

### SUMMARY OF THE INVENTION

One exemplary embodiment of the present invention provides a device and method for decreasing power consumption in an electronic device capable of wirelessly connecting components with each other.

Another exemplary embodiment of the present invention provides a device and method for determining a use state of a peripheral device in an electronic device capable of wirelessly connecting components with each other.

A further exemplary embodiment of the present invention provides a device and method for controlling the power consumption of a peripheral device in accordance with a use state of the peripheral device in an electronic device capable of wirelessly connecting components with each other.

A yet another exemplary embodiment of the present invention provides a device and method for enhancing a user's convenience in an electronic device capable of wirelessly connecting components with each other.

A method for operating a peripheral device in an electronic device capable of wirelessly connecting components with each other according to an exemplary embodiment of the present invention, characterized in that the method includes the steps of detecting that a contact occurs in at least one predetermined point of the peripheral device, and supplying power to at least one module located in the peripheral device.

A method for operating a body in an electronic device capable of wirelessly connecting components with each other according to another exemplary embodiment of the present invention, characterized in that the method includes the steps of receiving, from a peripheral device, a first wireless signal informing that a contact occurs at a predetermined point of the peripheral device, receiving a second wireless signal informing that the contact at the point is removed, and if it is not notified that a contact again occurs at the point until before the expiration of a timer corresponding to the point after initiating the timer, transmitting, to the peripheral device, a third wireless signal informing the expiration of the timer.

A peripheral device in an electronic device capable of wirelessly connecting components with each other according to a further exemplary embodiment of the present invention, characterized in that the peripheral device includes at least one sensor detecting that a contact occurs in at least one predetermined point of the peripheral device, and a power supply unit supplying power to at least one module located in the peripheral device.

A body device in an electronic device capable of wirelessly connecting components with each other according to a yet another exemplary embodiment of the present invention, characterized in that the body device includes a wireless communication module receiving, from a peripheral device, a first wireless signal informing that a contact occurs at a predetermined point of the peripheral device, and receiving a second wireless signal informing that the contact at the point is removed, and a control unit controlling the wireless communication module to transmit, to the peripheral device, a third wireless signal informing the expiration of the timer, if it is not notified that a contact again occurs at the point until before the expiration of a timer corresponding to the point after initiating the tinier.

The present invention determines a use state of a peripheral device through sensing and controls a supply of power of an internal module, thereby being capable of decreasing unnecessary power consumption, and enhancing a user's convenience in an electronic device capable of wirelessly connecting components with each other.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating an example of an electronic device including a plurality of components;

FIG. 2 is a diagram illustrating one example of a structure of a peripheral device in an electronic device according to an exemplary embodiment of the present invention;

FIG. 3 is a diagram illustrating a state diagram of a peripheral device in an electronic device according to an exemplary embodiment of the present invention;

FIG. 4 is a diagram illustrating a state diagram of a peripheral device in an electronic device according to another exemplary embodiment of the present invention;

FIG. 5 is a diagram illustrating a block construction of a peripheral device in an electronic device according to an exemplary embodiment of the present invention;

FIG. 6 is a diagram illustrating a block construction of a peripheral device in an electronic device according to another exemplary embodiment of the present invention;

FIG. 7 is a diagram illustrating block constructions of a peripheral device and a body in an electronic device according to a further exemplary embodiment of the present invention;

FIG. 8 is a diagram illustrating a state control procedure of a peripheral device in an electronic device according to an exemplary embodiment of the present invention;

FIG. 9 is a diagram illustrating a state control procedure of a peripheral device in an electronic device according to another exemplary embodiment of the present invention;

FIG. 10A and FIG. 10B are diagrams illustrating a state control procedure of a peripheral device in an electronic device according to a further exemplary embodiment of the present invention;

FIG. 11 is a diagram illustrating a signal exchange of a peripheral device and a body in an electronic device according to an exemplary embodiment of the present invention;

FIG. 12 is a diagram illustrating a construction of a sensor related message exchanged between a peripheral device and a body in an electronic device according to an exemplary embodiment of the present invention;

FIG. 13 is a diagram illustrating a construction of a timer related message exchanged between a peripheral device and a body in an electronic device according to an exemplary embodiment of the present invention;

FIG. 14 is a diagram illustrating an operation procedure of a peripheral device in an electronic device according to an exemplary embodiment of the present invention;

FIG. 15 is a diagram illustrating an operation procedure of a peripheral device in an electronic device according to another exemplary embodiment of the present invention;

FIG. 16 is a diagram illustrating an operation procedure of a peripheral device in an electronic device according to a further exemplary embodiment of the present invention;

FIG. 17 is a diagram illustrating an operation procedure of a peripheral device in an electronic device according to a yet another exemplary embodiment of the present invention; and

FIG. 18 is a diagram illustrating an operation procedure of a body in an electronic device according to an exemplary embodiment of the present invention.

### DETAILED DESCRIPTION OF THE PREFERRED EMBODIMENTS

Preferred embodiments of the present invention will be described herein below with reference to the accompanying drawings. In describing the present invention, well-known functions or constructions are not described in detail since they would obscure the invention in unnecessary detail. And, terms described below, which are defined considering functions in the present invention, can be modified in accordance to user and operator's intention or practice. Therefore, the definition should be given on the basis of the content throughout the present specification.

Below, the present invention describes a technology for operation control in an electronic device including wirelessly connectable components.

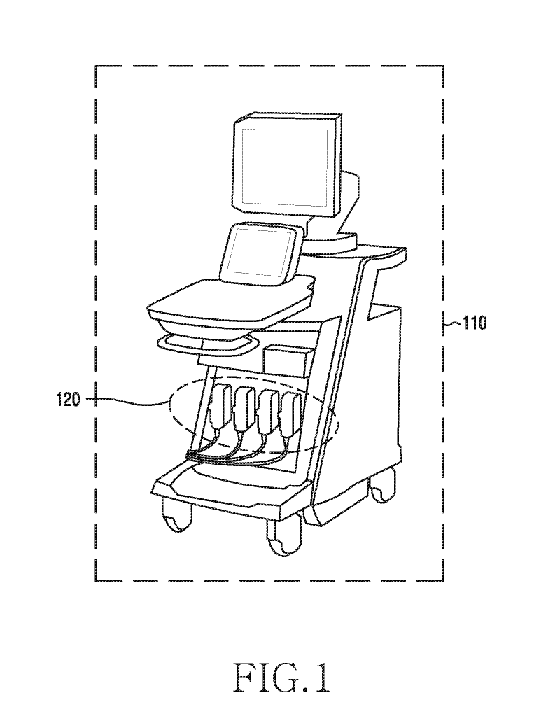

FIG. 1 illustrates an example of an electronic device including a plurality of components. The FIG. 1 illustrates ultrasonic diagnosis equipment, as an example of the electronic device.

The ultrasonic diagnosis equipment used in the medical field refers to equipment generating an ultrasonic wave, and imaging and showing a returning ultrasonic wave. The ultrasonic diagnosis equipment chiefly includes a body 110 generating and displaying an image on the basis of a time difference of a reflected wave of an ultrasonic wave and a strength/weakness, and a component 120 generating an ultrasonic wave and detecting a returning ultrasonic wave. The component 120 may be named a ‘probe device’. Commonly, the probe device 120 of the conventional ultrasonic diagnosis equipment is wiredly connected with a system body. Because operations of the probe device 120 may be all managed in the body 110 and be wiredly supplied power, the power consumption of the probe device 120 is not greatly problematic. However, in recent years, demand has been increased for attempts to wirelessly connect the probe device 120 and the body 110 in the ultrasonic diagnosis equipment, and research and development on this are being made actively.

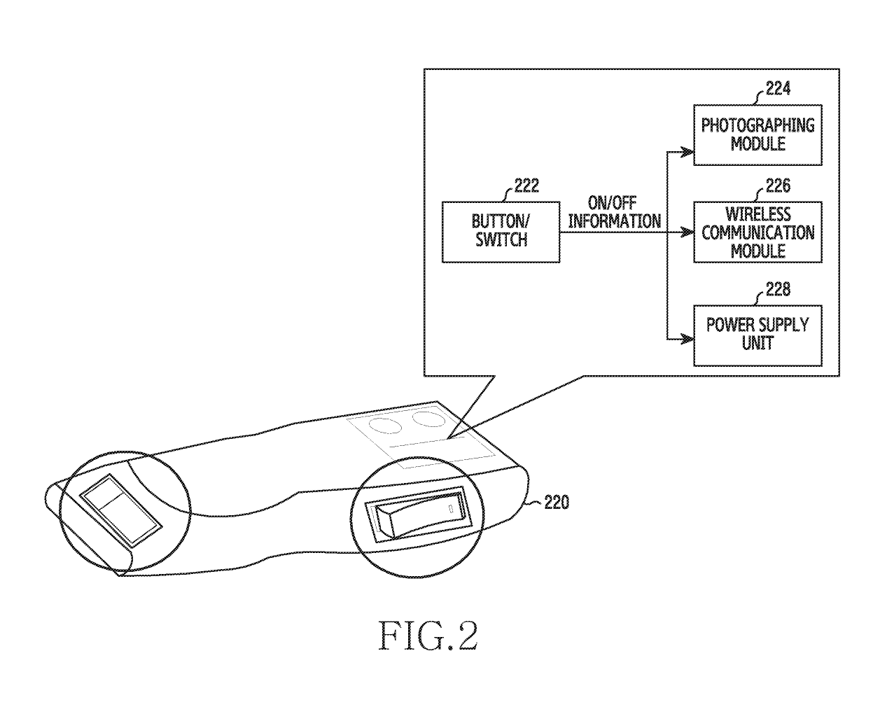

In case that the probe device 120 and the body 110 are wirelessly connected with each other, a supply of power through a wire cannot be accomplished as in the existing. Also, because a control instruction cannot be received all the time from the body 110, a user interface and device for initiating separate measurement is required. In this case, a construction example of the probe device 120 is given as in FIG. 2 below FIG. 2 illustrates one example of a structure of a petipheral device in an electronic device according to an exemplary embodiment of the present invention. The FIG. 2 illustrates a construction example of a probe device 220.

Referring to the FIG. 2, the probe device 220 includes a button/switch 222, a photographing module 224, a wireless communication module 226, and a power supply unit 228. The button/switch 222, a user interface for controlling the probe device 220, may have a form of a button or switch. The photographing module 224 generates an ultrasonic signal, and measures a signal strength of a reflected ultrasonic wave, a time difference, etc. The wireless communication module 226 performs wireless communication with a body, thereby transmitting and exchanging necessary information. The power supply unit 228 supplies power required for the probe device 220 to operate. A supply of power of the power supply unit 228 may be controlled by the button/switch 222. As illustrated in the FIG. 2, due to a wireless connection, an interface for state control of the probe device 220 is additionally required.

As mentioned above, in case that a probe device and a system body are wirelessly connected with each other, control such as manually handling a button or switch is required to initiate measurement or power On. That is, there is a difficulty in synchronization of a measurement time point of the probe device. Also, an interface (e.g., a button, a switch, etc.) is required for measurement initiation of the probe device or data transmission. These additional operations and devices may be the causes of much deteriorating a user's convenience. Also, a wired power supply is impossible. Accordingly, there occurs a problem of getting very sensitive to power consumption, because there is a need to employ batteries. Particularly, in case of a photographing module, there may be a difficulty in the long use of the probe device, because power consumption is relatively large.

Accordingly, various exemplary embodiments of the present invention provide a technology for decreasing power consumption in an electronic device capable of wirelessly connecting components with each other such as the aforementioned ultrasonic inspection equipment, and providing a more convenient control interface. In the above description, the ultrasonic inspection equipment has been given as an example, but, provided it is an electronic device consisting of wirelessly connectable components besides the ultrasonic inspection equipment, the present invention may be identically applicable to it.

An electronic device considered in the present invention includes a ‘body’ capable of wirelessly connecting components with each other and performing a function intimate with a use of the electronic device, and a ‘peripheral device’ transmitting measured, inputted or generated information to the ‘body’. In the following description, the present invention uses the terms ‘body’, ‘peripheral device’, but the ‘body’ and the ‘peripheral device’ may be expressed by other terms within a scope representing the equivalent technological meaning.

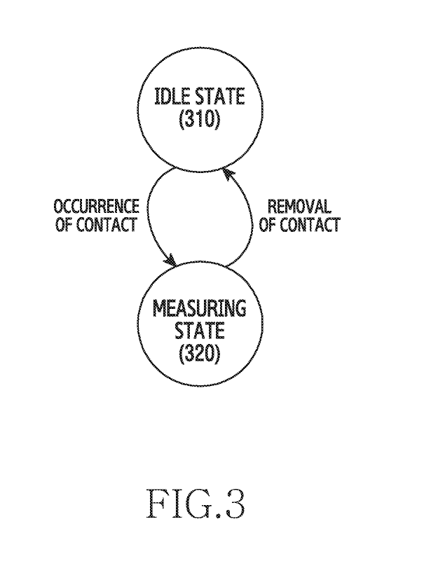

FIG. 3 illustrates a state diagram of a peripheral device in an electronic device according to an exemplary embodiment of the present invention.

Referring to the FIG. 3, the peripheral device may have an idle state 310 and a measuring state 320. The idle state 310, a situation in which modules for operation turn Off, refers to a state of minimizing power consumption. The measuring state 320, a situation in which all modules necessary for operation are operated, refers to a state of consuming power. For example, in case that the peripheral device is a probe of ultrasonic inspection equipment, in the measuring state 320, the peripheral device measures an ultrasonic wave and a reflected wave through the photographing module, and transmits generated data to a body.

At least, the peripheral device is put in the idle state 310. In the idle state 310, if a contact occurs in a specific point of the peripheral device, the peripheral device makes a transition to the measuring state 320. That is, by detecting the occurrence of the contact as an intention that a user intends to make use of the peripheral device, the peripheral device makes a transition to the measuring state 320. Here, the contact may be a contact with a user or a contact with a target related with a use state of the peripheral device. A point determining the contact may be different according to the kind of a contact that is a basis of the state transition. In the measuring state 320, if the separation occurs, in other words, if the contact is removed, the peripheral device makes a transition to the idle state 310. At this time, to prevent On/Off repetition of modules caused by temporary separation, the peripheral device may make a transition to the idle state 310, only in case that the separation is maintained during a constant time.

The aforementioned states of the peripheral device are divided according to power supply states of internal modules, That is, the idle state 310 represents a state in which power is not supplied to corresponding modules, and the measuring state 320 a state in which power is supplied to the corresponding modules. That is, the aforementioned states may be expressed by a supply or non-supply of power to the corresponding modules, and that the state is transitioned represents that a combination of the modules supplied power is changed.

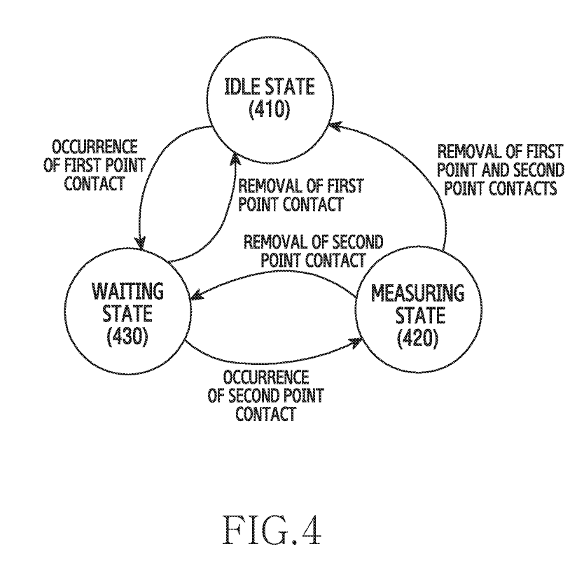

FIG. 4 illustrates a state diagram of a peripheral device in an electronic device according to another exemplary embodiment of the present invention.

Referring to the FIG. 4, the peripheral device may have an idle state 410, a measuring state 420, a waiting state 430. The idle state 410, a situation in which modules for operation turn Off, refers to a state of minimizing power consumption. The measuring state 420, a situation in which all modules necessary for operation are operated, refers to a state of consuming power. For example, in case that the peripheral device is a probe of ultrasonic inspection equipment, in the measuring state 420, the peripheral device measures an ultrasonic wave and a reflected wave through the photographing module, and transmits generated data to a body. The waiting state 430, a situation in which only some modules turn On, refers to a state in which a transition to the measuring state 420 may be made relatively faster than in the idle state 410. For example, in case that the peripheral device is a probe of ultrasonic inspection equipment, in the waiting state 430, the peripheral device turns On a wireless communication module, and establishes a wireless connection with a body, thereby completing a preparation for transmitting photographing data.

Unlike the state diagram illustrated in the FIG. 3, the exemplary embodiment illustrated in the FIG. 4 further includes the waiting state 430. Determining the waiting state 430 and the measuring state 420 is identically based on contact or non-contact, but there is a difference in a contact point. That is, the waiting state 430 is transitioned when a user gets in contact with the peripheral device, and the measuring state 420 is transitioned when he/she gets in contact with a target for use (e.g., photographing in case of ultrasonic inspection equipment) of the peripheral device. For example, in case that the peripheral device is a probe of the ultrasonic inspection equipment, a contact point (below, a ‘first point’) for determination of the waiting state 430 may be a handle portion of the probe device. Also, in case that the peripheral device is the probe of the ultrasonic inspection equipment, a contact point (below, a ‘second point’) for determination of the measuring state 420 is a portion coming in touch with an inspection target at ultrasonic inspection, and may be a portion outputting and detecting an ultrasonic wave.

Least, the peripheral device is put in the idle state 410. In the idle state 410, if a contact occurs at the first point of the peripheral device, the peripheral device makes a transition to the waiting state 430. In the waiting state 430, if separation occurs at the first point, in other words, if the contact at the first point is removed, the peripheral device makes a transition to the idle state 410. In contrast, if a contact occurs at the second point of the peripheral device while the contact at the first point exists, the peripheral device makes a transition to the measuring state 420. In the measuring state 420, if separation occurs at the second point with the contact at the first point being kept, the petipheral device makes a transition to the waiting state 420. In contrast, in the measuring state 420, if the contacts in all of the first point and the second point are removed, the peripheral device makes a transition to the idle state 410. In case that state transition is made by the separation, to prevent On/Off repetition of modules caused by temporary separation, the peripheral device may make the state transition, only in case that the separation is maintained during a constant time.

The aforementioned states of the peripheral device are divided according to power supply states of internal modules. That is, in case of the FIG. 4, it has a stepwise power supply state, and a combination of modules supplied power gets different according to each state. That is, the peripheral device may identify a combination of at least one point at which a contact has occurred, and determine a combination of modules to be supplied power according to the combination.

As mentioned above, a plurality of states such as an idle state, a waiting state, a measuring state, etc. are supported, whereby efficient power management is made possible and concurrently, a delay time required for transmitting photographing data may be minimized.

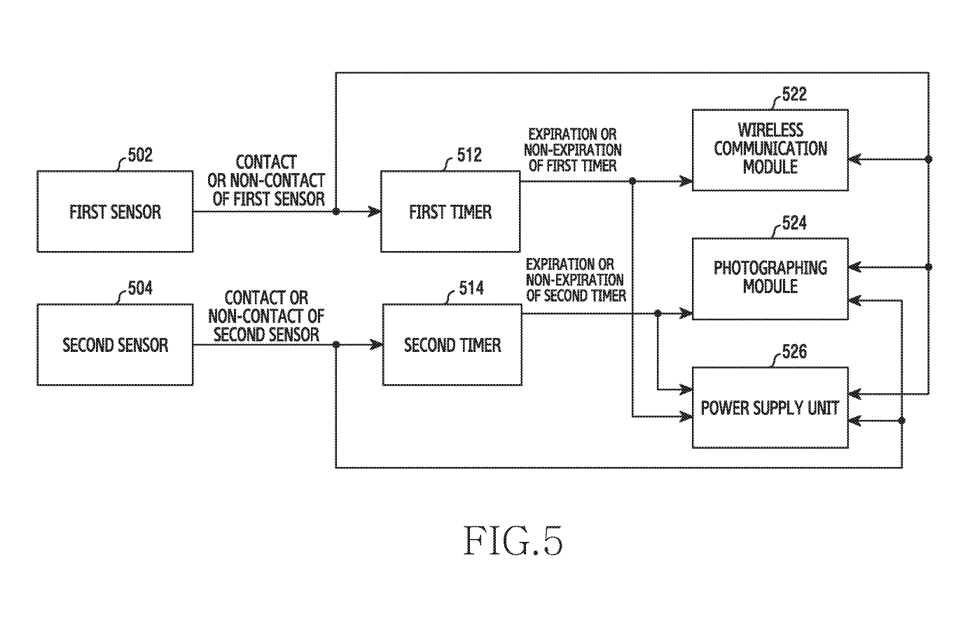

FIG. 5 illustrates a block construction of a peripheral device in an electronic device according to an exemplary embodiment of the present invention. The FIG. 5 illustrates a block construction of a peripheral device which is operable in three states as in the FIG. 4. The FIG. 5 exemplifies a case in which the peripheral device is a device for photographing.

Referring to the FIG. 5, the peripheral device includes a first sensor 502, a second sensor 504, a first timer 512, a second timer 514, a wireless communication module 522, a photographing module 524, and a power supply unit 526.

To determine contact or non-contact, the first sensor 502. and the second sensor 504 may include at least one of a heat sensor, a motion detection sensor, a pressure sensor, a touch sensor, a contact sensor, a temperature sensor, an electricity sensor, and other contact or non-contact determinable sensors. The first sensor 502 determines contact or non-contact, and notifies the occurrence of a contact and the removal of the contact to the first timer 512, the wireless communication module 522, and the power supply unit 526. The second sensor 504 determines contact or non-contact, and notifies the occurrence of a contact and the removal of the contact to the second timer 514, the photographing module 524, and the power supply unit 526. Here, the contact or non-contact may be determined on the basis of the measurement result of at least one of the heat sensor, the motion detection sensor, the pressure sensor, the touch sensor, the contact sensor, the temperature sensor, the electric sensor and the other contact or non-contact determinable sensors.

The first timer 512 initiates the counting of a timer value in accordance with contact or non-contact notified from the first sensor 502, or resets the timer value. In detail, if the removal of a contact is notified, the first timer 512 initiates the counting and, if it is notified that a contact again occurs during the counting, the first timer 512 resets. And, if the timer expires, the first timer 512 notifies the tinier expiration to the wireless communication module 522, the power supply unit 526. The second timer 514 initiates the counting of a timer value in accordance with contact or non-contact notified from the second sensor 504, or resets the timer value. In detail, if the removal of a contact is notified, the second timer 514 initiates the counting and, if it is notified that a contact again occurs during the counting, the second timer 514 resets. And, if the timer expires, the second timer 514 notifies the timer expiration to the photographing module 524, the power supply unit 526. The counting value counted by the first timer 512 and the second timer 514 may get different according to a concrete exemplary embodiment.

The wireless communication module 522 performs a wireless communication with a body, thereby transmitting and exchanging necessary information. For example, the wireless communication module 522 transmits photographing data generated by the photographing module 524. The wireless communication module 522 is supplied power from the power supply unit 526. The photographing module 524 performs a function for photographing. For example, in case that the peripheral device is a probe of ultrasonic inspection equipment, the photographing module 524 generates an ultrasonic signal, and measures a signal strength of a reflected ultrasonic wave, a time difference, etc. The photographing module 524 is supplied power from the power supply unit 526. The power supply unit 526 supplies power to other modules, for example, the wireless communication module 522, the photographing module 524. A supply or non-supply of power of the power supply unit 526 is determined by the sensing results of the first sensor 502 and the second sensor 504, the first timer 512 and the second timer 514. That is, a state of the peripheral device is determined by the sensing results of the first sensor 502 and the second sensor 504, the first timer 512 and the second timer 514.

In accordance with the sensing result of the first sensor 502, the peripheral device makes a transition from an idle state to a waiting state. In detail, if the occurrence of a contact is notified in the first sensor 502, the power supply unit 526 supplies power to the wireless communication module 522. Accordingly to this, the wireless communication module 522 may establish a wireless connection with a body.

In accordance with the sensing result of the second sensor 504, the peripheral device makes a transition from the waiting state to a measuring state. In detail, if the occurrence of a contact is notified in the second sensor 504, the power supply unit 526 supplies power to the photographing module 524. Accordingly to this the photographing module 524 may initiate photographing.

By the first timer 512 and the first sensor 502, the peripheral device makes a transition from the waiting state to an idle state. In detail, if the removal of a contact is notified in the first sensor 502 and the expiration of a timer value is notified in the first timer 512, the power supply unit 526 cuts off power to the wireless communication module 522. Accordingly to this, the wireless communication module 522 does not consume power.

By the second timer 514 and the second sensor 504, the peripheral device makes a transition from the measuring state to the waiting state. In detail, if the removal of a contact is notified in the second sensor 504 and the expiration of a timer value is notified in the second timer 514, the power supply unit 526 cuts off power to the photographing module 524. Accordingly to this, the photographing module 524 does not consume power.

By the first sensor 502 and the second sensor 504, the peripheral device makes a transition from the measuring state to the idle state, in detail, if the removal of a contact is notified in the first sensor 502 and the removal of a contact is notified in the second sensor 504, the power supply unit 526 cuts off power to the wireless communication module 522 and power to the photographing module 524. Accordingly to this, the wireless communication module 522 and the photographing module 524 do not consume power. At this time, the power supply unit 526 may further consider the expiration or non-expiration of timer values of the first timer 512 and the second timer 514, in addition to the sensing results of the first sensor 502 and the second sensor 504.

Although not illustrated in the FIG. 5, the peripheral device may include a control unit controlling the whole operation of the peripheral device, In this case, the control unit may control the start of the first timer 512 and the second timer 514, and determine expiration or non-expiration. Further, the first timer 512 and the second timer 514 may be included in the control unit.

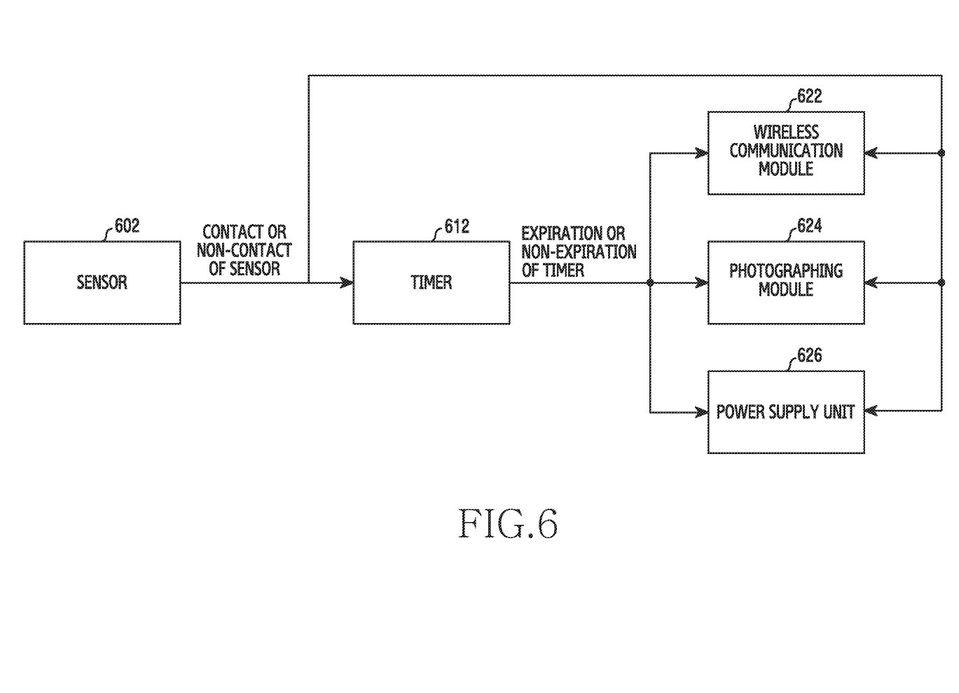

FIG. 6 illustrates a block construction of a peripheral device in an electronic device according to another exemplary embodiment of the present invention. The FIG. 6 illustrates a block construction of a peripheral device which is operable in two states as in the FIG. 3. The FIG. 6 exemplifies a case in which the peripheral device is a device for photographing.

Referring to the FIG. 6, the peripheral device includes a sensor 602, a timer 612, a wireless communication module 622, a photographing module 624, and a power supply unit 626.

To determine contact or non-contact, the sensor 602. may include at least one of a heat sensor, a motion detection sensor, a pressure sensor, a touch sensor, a contact sensor, a temperature sensor, an electricity sensor, and other contact or non-contact determinable sensors. The sensor 602 determines contact or non-contact, and notifies the occurrence of a contact and the removal of the contact to the timer 612, the wireless communication module 622, the photographing module 624, and the power supply unit 626.

The timer 612 initiates the counting of a timer value in accordance with contact or non-contact notified from the sensor 602, or resets the timer value. In detail, if the removal of a contact is notified, the timer 612 initiates the counting and, if it is notified that a contact again occurs during the counting, the timer 612 resets. And, if the timer expires, the timer 612 notifies the timer expiration to the wireless communication module 622, the photographing module 624, the power supply unit 626. And, if the timer expires, the timer 612 notifies the timer expiration to the wireless communication module 622, the photographing module 624, the power supply unit 626. The counting value counted by the timer 612 and may get different according to a concrete exemplary embodiment.

The wireless communication module 622 performs a wireless communication with a body, thereby transmitting and exchanging necessary information. For example, the wireless communication module 622 transmits photographing data generated by the photographing module 624. The wireless communication module 622 is supplied power from the power supply unit 626. The photographing module 624 performs a function for photographing. For example, in case that the peripheral device is a probe of ultrasonic inspection equipment, the photographing module 624 generates an ultrasonic signal, and measures a signal strength of a reflected ultrasonic wave, a time difference, etc. The photographing module 624 is supplied power from the power supply unit 626. The power supply unit 626 supplies power to other modules, for example, the wireless communication module 622, the photographing module 624. A supply or non-supply of power of the power supply unit 626 is determined by the sensing result of the sensor 602, the timer 612. That is, a state of the peripheral device is determined by the sensing result of the sensor 602, the timer 612.

In accordance with the sensing result of the sensor 602, the peripheral device makes a transition from an idle state to a measuring state. In detail, if the occurrence of a contact is notified in the sensor 602, the power supply unit 626 supplies power to the wireless communication module 622, the photographing module 624. Accordingly to this, the wireless communication module 622 may establish a wireless connection with a body, and the photographing module 624 may initiate photographing.

By the timer 612 and the sensor 602, the peripheral device makes a transition from the measuring state to the idle state. In detail, if the removal of a contact is notified in the sensor 602 and the expiration of a timer value is notified in the timer 612, the power supply unit 626 cuts off power to the wireless communication module 622 and power to the photographing module 624. Accordingly to this, the wireless communication module 622 and the photographing module 624 do not consume power.

Although not illustrated in the FIG. 6, the peripheral device may include a control unit controlling the whole operation of the peripheral device. In this case, the control unit may control the start of the timer 612 and, and determine expiration or non-expiration. Further, the timer 612 may be included in the control unit.

In embodying the present invention in accordance with the aforementioned exemplary embodiment, a timer may consist of one, or may even consist of a plurality of timers in accordance with an implementation method. Also, the timer may be included in a peripheral device, or may be included in a body. Also, a timer value may be dynamically adjusted according to a situation.

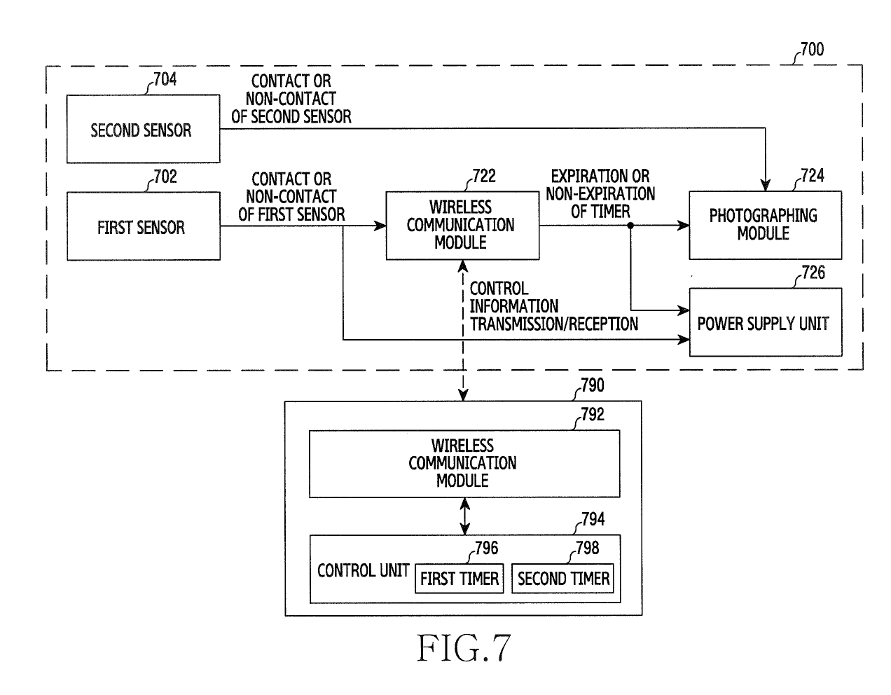

FIG. 7 illustrates block constructions of a peripheral device and a body in an electronic device according to a further exemplary embodiment of the present invention. The FIG. 7 illustrates a block construction of a peripheral device which is operable in three states as in the FIG. 4. The FIG. 7 exemplifies a case in which the peripheral device is a device for photographing.

Referring to the FIG. 7, the peripheral device 700 includes a first sensor 702, a second sensor 704, a wireless communication module , a photographing module 724, and a power supply unit 726.

To determine contact or non-contact, the first sensor 702 and the second sensor 704 may include at least one of a heat sensor, a motion detection sensor, a pressure sensor, a touch sensor, a contact sensor, a temperature sensor, an electricity sensor, and other contact or non-contact determinable sensors. The first sensor 702 determines contact or non-contact, and notifies the occurrence of a contact to the wireless communication module 722, the power supply unit 726. And, the first sensor 702 notifies the removal of a contact to the wireless communication module 722. The second sensor 704 determines contact or non-contact, and notifies the occurrence of a contact to the second timer 714, the wireless communication module 722, the photographing module 724, the power supply unit 726. And, the second sensor 704 notifies the removal of a contact to the wireless communication module 722.

The wireless communication module 722 performs a wireless communication with a wireless communication module 792 of a body 790, thereby transmitting and exchanging necessary information. For example, the wireless communication module 722 transmits photographing data generated by the photographing module 724. And, the wireless communication module 722 transmits, to the body 790, a signal informing the occurrence of a contact or the removal of the contact notified in the first sensor 702 and the second sensor 704, and receives a signal informing the expiration of a timer value from the wireless communication module 792. Here, the timer value includes a first timer value corresponding to the first sensor 702 and a second timer value corresponding to the second sensor 704. Upon receiving a signal informing the expiration of the first timer value or the second timer value, the wireless communication module 722 notifies the expiration of the corresponding timer value to the power supply unit 726. The wireless communication module 722 may further notify the expiration of the timer value to the photographing module 724. The wireless communication module 722 is supplied power from the power supply unit 726.

The photographing module 724 performs a function for photographing. For example, in case that the peripheral device is a probe of ultrasonic inspection equipment, the photographing module 724 generates an ultrasonic signal, and measures a signal strength of a reflected ultrasonic wave, a time difference, etc. The photographing module 724 is supplied power from the power supply unit 726. The power supply unit 726 supplies power to other modules, for example, the wireless communication module 722, the photographing module 724. A supply or non-supply of power of the power supply unit 726 is determined by the sensing results of the first sensor 702 and the second sensor 704, the expiration or non-expiration of each timer value notified from the wireless communication module 722. That is, a state of the peripheral device 700 is determined by the sensing results of the first sensor 702 and the second sensor 704, the expiration or non-expiration of the timer value.

Also, referring to the FIG. 7, the body 790 includes the wireless communication module 792, a control unit 794. The wireless communication module 792 performs a wireless communication with the wireless communication module 722 of the peripheral device 700, thereby transmitting and exchanging necessary information. For example, the wireless communication module 792 receives photographing data generated by the photographing module 724. And, the wireless communication module 792 receives a wireless signal informing the occurrence of a contact or the removal of the contact sensed by the first sensor 702 and the second sensor 704.

Upon receiving a wireless signal infonning the removal of a contact, the control unit 794 initiates a corresponding timer among a first timer 796 and a second timer 798. That is, if it is notified that a contact in the first sensor 702 does not exist, the control unit 794 initiates the first timer 796. Thereafter, if the first timer 795 expires before it is notified that the contact in the first sensor 702 exists, the control unit 794 notifies the expiration of the first tinier 796 to the wireless communication module 792, and the wireless communication module 792 transmits a wireless signal informing the expiration of the first timer 796 to the peripheral device 700.

Also, if it is notified that a contact in the second sensor 702 does not exist, the control unit 794 initiates the second timer 798, Thereafter, if the second timer 798 expires before it is notified that the contact in the second sensor 704 exists, the control unit 794 notifies the expiration of the second timer 798 to the wireless communication module 792, and the wireless communication module 792 transmits a wireless signal informing the expiration of the second timer 798 to the peripheral device 700.

In accordance with the sensing result of the first sensor 702, the peripheral device 700 makes a transition from an idle state to a waiting state. In detail, if the occurrence of a contact is notified in the first sensor 702, the power supply unit 726 supplies power to the wireless communication module 722. Accordingly to this, the wireless communication module 722 may establish a wireless connection with the body 790.

In accordance with the sensing result of the second sensor 704, the peripheral device 700 makes a transition from the waiting state to a measuring state In detail, if the occurrence of a contact is notified in the second sensor 704, the power supply unit 726 supplies power to the photographing module 724. Accordingly to this, the photographing module 724 may initiate photographing.

By the expiration of the first timer value and the timer 712 and the first sensor 702, the peripheral device 700 makes a transition from the waiting state to the idle state In detail, if the removal of a contact is notified in the first sensor 702 and the expiration of the timer value is notified in the first timer 712, the power supply unit 726 cuts off power to the wireless communication module 722. Accordingly to this, the wireless communication module 722 does not consume power.

By the expiration of the second tinier value and the second sensor 704, the peripheral device 700 makes a transition from the measuring state to the waiting state. In detail, if the removal of a contact is notified in the second sensor 704 and the expiration of the timer value is notified in the second timer 714, the power supply unit 726 cuts off power to the photographing module 724. Accordingly to this, the photographing module 724 does not consume power.

By the first sensor 702 and the second sensor 704, the peripheral device 700 makes a transition from the measuring state to the idle state. In detail, if the removal of a contact is notified in the first sensor 702 and the removal of a contact is notified in the second sensor 704, the power supply unit 726 cuts off power to the wireless communication module 722 and power to the photographing module 724. Accordingly to this, the wireless communication module 722 and the photographing module 724 do not consume power. At this time, the power supply unit 726 may further consider the expiration or non-expiration of the first timer value and the second timer value, in addition to the sensing results of the first sensor 702 and the second sensor 704.

The FIG. 7 illustrates the exemplary embodiment in which the timer is included in the body 790 in case that the peripheral device 700 is operable in three states as in the FIG. 4. However, in accordance with another exemplary embodiment of the present invention, even in case that the peripheral device 700 is operable in two states as in the FIG. 3, the timer may be included in the body similarly to the FIG. 7.

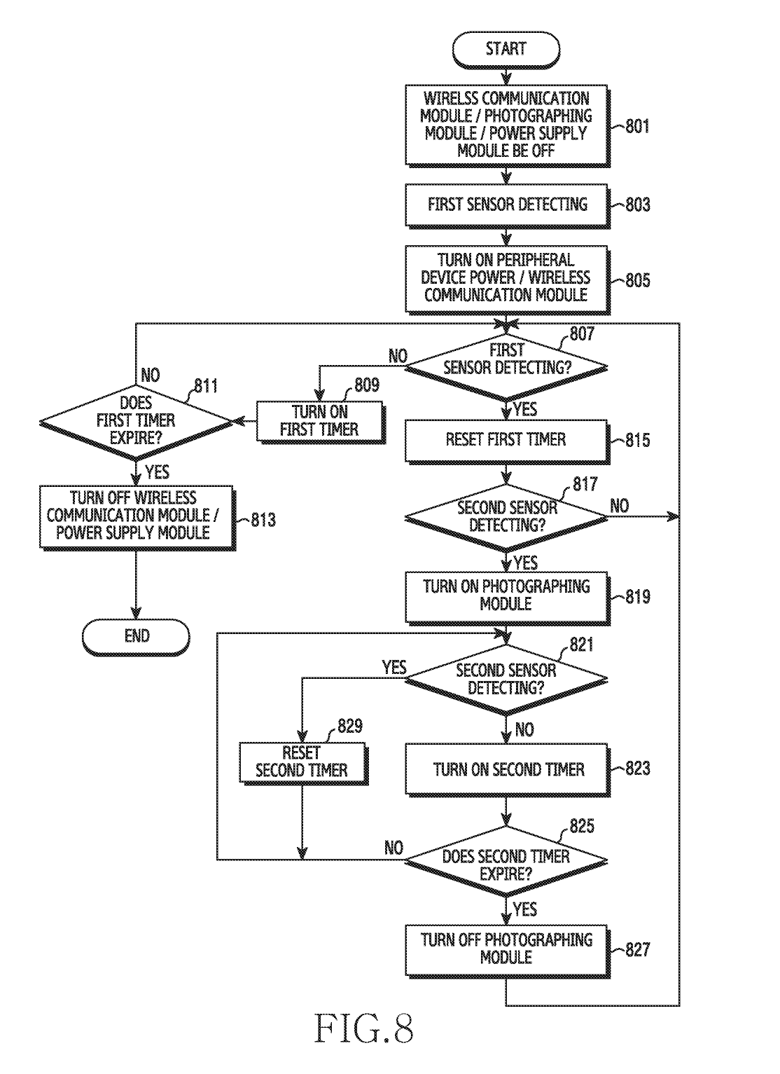

FIG. 8 illustrates a state control procedure of a peripheral device in an electronic device according to an exemplary embodiment of the present invention.

Referring to the FIG. 8, in step 801, the peripheral device is in a state of turning Off a wireless communication module, a photographing module, a power supply module. That is, the peripheral device is in an idle state. Next, the peripheral device proceeds to step 803 and detects a contact through a first sensor. Here, the contact may be detected through a heat sensor, a motion detection sensor, a pressure sensor, a touch sensor, a contact sensor, a temperature sensor, an electricity sensor and other contact or non-contact determinable sensors. Accordingly to this, the peripheral device proceeds to step 805 and turns On the power supply module and the wireless communication module. That is, the peripheral device turns On power of the peripheral device, and operates the wireless communication module. In other words, if the contact is detected in the first sensor, the peripheral device makes a transition from the idle state to a waiting state. For this, the peripheral device operates the power supply module and the wireless communication module. At this time, the photographing module does not operate, but the peripheral device is in a state capable of transmitting photographing data to a body as soon as photographing is initiated.

Thereafter, the peripheral device proceeds to step 807 and determines if the contact is kept being detected in the first sensor. If the contact is not detected in the first sensor, the peripheral device proceeds to step 809 and turns On a first timer, in other words, initiates the counting of a first timer value. Thereafter, the peripheral device proceeds to step 811 and determines if the first timer expires. If the first timer expires, the peripheral device proceeds to step 813 and turns Off the wireless communication module, the power supply module. That is, the peripheral device stops an operation of the wireless communication module, and powers off the peripheral device. That is, while the contact is detected in the first sensor, the peripheral device keeps maintaining the waiting state. If the contact is not detected in the first sensor, the peripheral device operates the first timer. If the first timer expires, the peripheral device returns to the idle state. In contrast, if the first timer does not expire, the peripheral device returns to the step 807.

If the contact is detected in the first sensor in the step 807, the peripheral device proceeds to step 815 and resets the first timer. That is, the peripheral device restores the first timer to an initial state. However, if the first timer has not ever turned On, the step 815 may be omitted, Thereafter, the peripheral device proceeds to step 817 and determines if a contact is detected in a second sensor. If the contact is not detected in the second sensor, the peripheral device returns to the step 807. In contrast, if the contact is detected in the second sensor, the peripheral device proceeds to step 819 and turns On the photographing module. That is, if the contact is detected in the second sensor while the contact is kept being detected in the first sensor, the peripheral device makes a transition from the waiting state to a measuring state. For this, the peripheral device operates the photographing module. In the measuring state, photographing data generated in the photographing module is transmitted to the body through the wireless communication module.

Thereafter, the peripheral device proceeds to step 821 and determines if the contact is kept being detected in the second sensor, if the contact is not detected in the second sensor, the peripheral device proceeds to step 823 and turns On a second timer, in other words, initiates the counting of a second timer value. Thereafter, the peripheral device proceeds to step 825 and determines if the second timer expires. If the second timer expires, the peripheral device proceeds to step 827 and turns Off the photographing module. That is, the peripheral device stops an operation of the photographing module. While the contacts are detected in all of the first sensor and the second sensor, the peripheral device keeps maintaining the measuring state. If the contact in the second sensor is not detected, the peripheral device operates the second timer. If the second timer expires, the peripheral device stops the operation of the photographing module, thereby making a transition to the waiting mode.

In contrast, if the second timer does not expire, the peripheral device returns to the step 821. If the contact is detected in the second sensor in the step 821, the peripheral device proceeds to step 829 and resets the second timer. That is, the peripheral device restores the second timer to an initial state. That is, if a contact is again detected in the second sensor before the second timer expires, the peripheral device keeps maintaining the measuring state, and initializes parameters including the second timer. However, if the second timer has not ever turned On, the step 829 may be omitted.

According to an exemplary embodiment illustrated in the FIG. 8, in case that the peripheral device is in the measuring state, in other words, in case that the peripheral device performs a circular procedure of the step 821, the step 823, the step 825, step 829, the peripheral device may firstly make a transition to the waiting state and then, make a transition to the idle state. However, in accordance with another exemplary embodiment of the present invention, the peripheral device may make a transition from the measuring state to the idle state. That is, in case that contacts of all of the first sensor and the second sensor are not detected in the measuring state, the peripheral device may initiate the first timer and the second timer concurrently, independently. Thereafter, according as the first timer and the second timer expire, the peripheral device may make a transition to the idle state, without going through the waiting state.

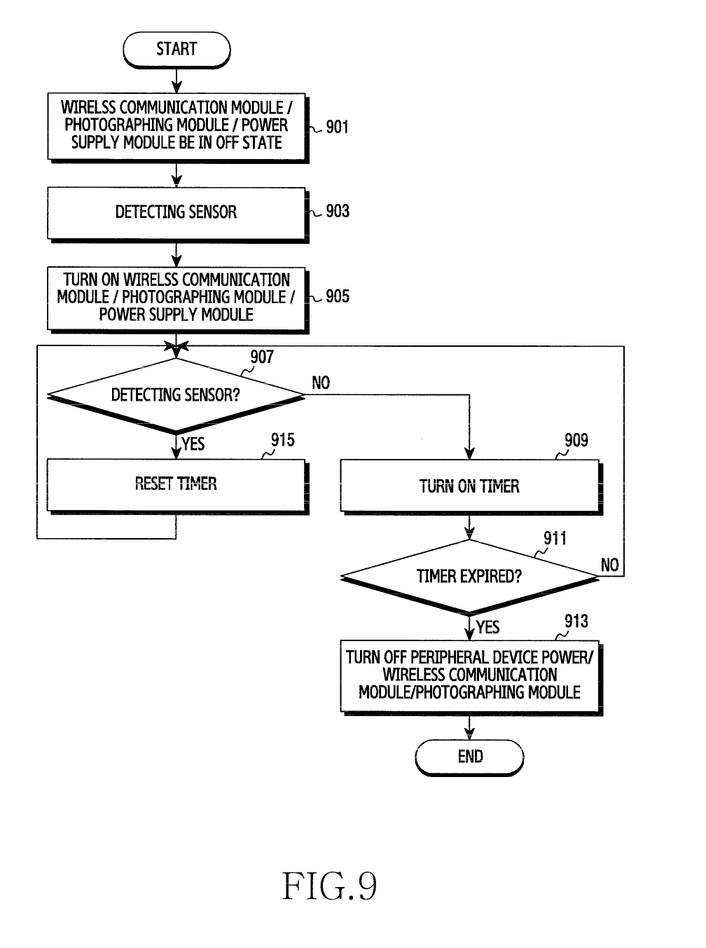

FIG. 9 illustrates a state control procedure of a peripheral device in an electronic device according to another exemplary embodiment of the present invention.

Referring to the FIG. 9, in step 901, the peripheral device turns Off a wireless communication module, a photographing module, a power supply module. Next, the peripheral device proceeds to step 903 and detects a contact through a sensor. Here, the contact may be detected through a heat sensor, a motion detection sensor, a pressure sensor, a touch sensor, a contact sensor, a temperature sensor, an electricity sensor and other contact or non-contact determinable sensors. Accordingly to this, the peripheral device proceeds to step 905 and turns On the power supply module, the wireless communication module, the photographing module. That is, the peripheral device turns On power of the peripheral device, and operates the wireless communication module and the photographing module. In other words, if the contact is detected in the sensor, the peripheral device makes a transition from an idle state to a measuring state. For this, the peripheral device operates the power supply module, the wireless communication module, the photographing module. In the measuring state, photographing data generated in the photographing module is transmitted to a body through the wireless unication mo

Thereafter, the peripheral device proceeds to step 907 and determines if the contact is kept being detected in the sensor. If the contact is not detected in the sensor, the peripheral device proceeds to step 909 and turns On a timer, in other words, initiates the counting of a timer value. Thereafter, the peripheral device proceeds to step 911 and determines if the timer expires. If the timer expires, the peripheral device proceeds to step 913 and turns Off the wireless communication module, the photographing module, the power supply module. That is, the peripheral device stops operations of the wireless communication module and the photographing module, and powers off the peripheral device. That is, while the contact is detected in the sensor, the peripheral device keeps maintaining the measuring state. If the contact is not detected in the sensor, the peripheral device operates the timer. If the timer expires, the peripheral device returns to the idle state.

In contrast, if the timer does not expire, the peripheral device returns to the step 907. If the contact is detected in the sensor in the step 907, the peripheral device proceeds to step 915 and resets the timer. That is, the peripheral device restores the timer to an initial state. However, if the timer has not ever turned On, the step 915 may he omitted. That is, while the contact is kept being detected in the sensor, the peripheral device maintains the measuring state.

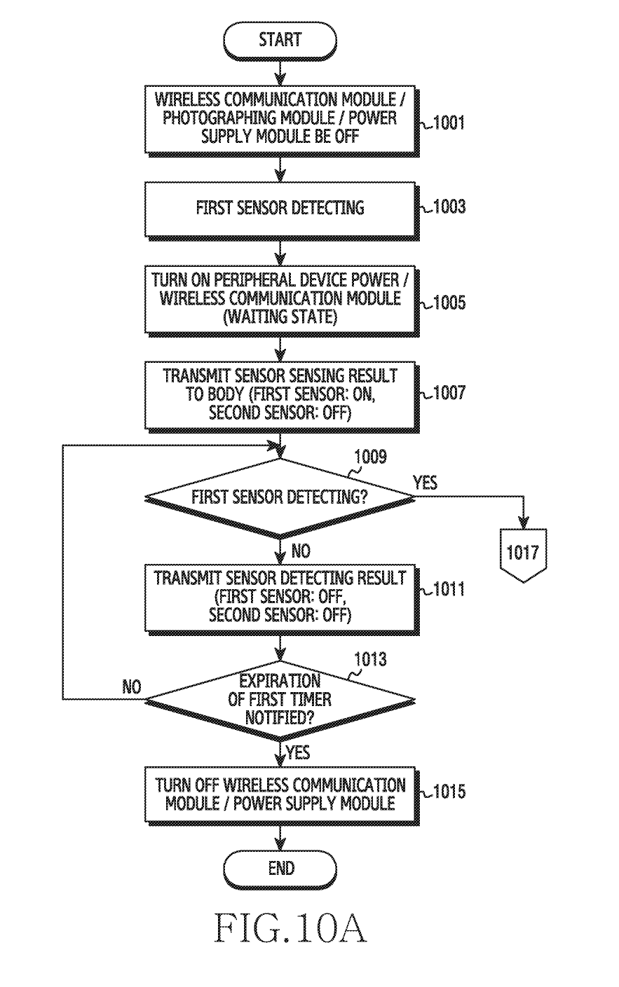

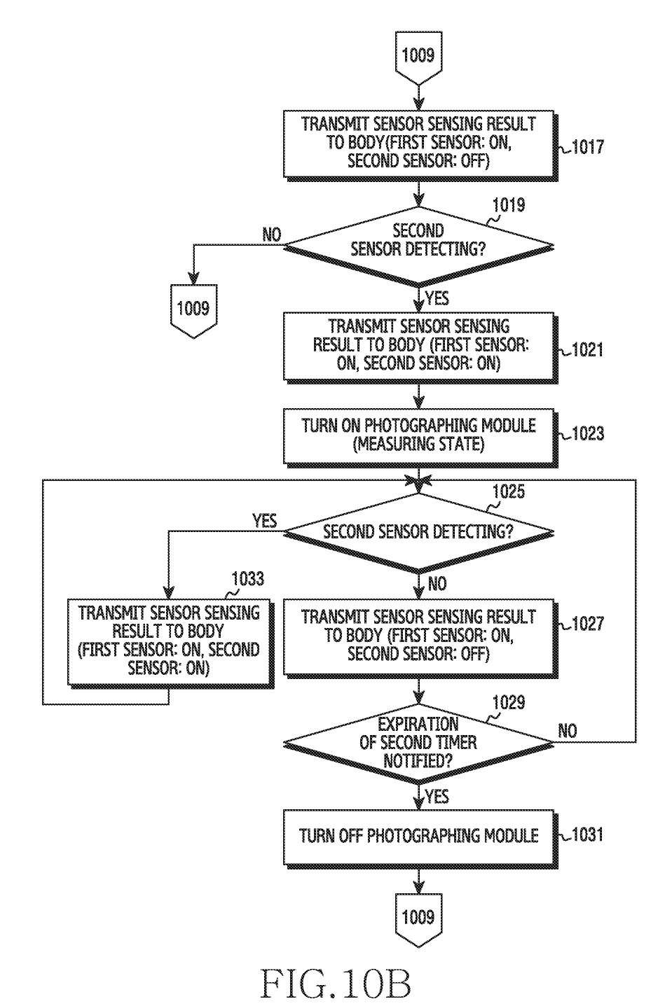

FIG. 10A and FIG 10B illustrate a state control procedure of a peripheral device in an electronic device according to a further exemplary embodiment of the present invention.

Referring to the FIG. 10A and FIG. 10B, in step 1001, the peripheral device is in a state of turning Off a wireless communication module, a photographing module, a power supply module. That is, the peripheral device is in an idle state. Next, the peripheral device proceeds to step 1003 and detects a contact through a first sensor. Here, the contact may be detected through a heat sensor, a motion detection sensor, a pressure sensor, a touch sensor, a contact sensor, a temperature sensor, an electricity sensor and other contact or non-contact determinable sensors. Accordingly to this, the peripheral device proceeds to step 1005 and turns On the power supply module and the wireless communication module. That is, the peripheral device turns On power of the peripheral device, and operates the wireless communication module. In other words, if the contact is detected in the first sensor, the peripheral device makes a transition from the idle state to a waiting state. For this, the peripheral device operates the power supply module and the wireless communication module. At this time, the photographing module does not operate, but the peripheral device is in a state capable of transmitting photographing data to a body as soon as photographing is initiated. And, the peripheral device proceeds to step 1007 and transmits the detection results of the first sensor and a second sensor to a body through the wireless communication module. That is, the peripheral device notifies that the contact is detected in the first sensor.

Thereafter, the peripheral device proceeds to step 1009 and determines if the contact is kept being detected in the first sensor. If the contact is not detected in the first sensor, the peripheral device proceeds to step 1011 and transmits the detection results of the first sensor and the second sensor to the body through the wireless communication module. That is, the peripheral device notifies that the contact is not detected in the first sensor. Thereafter, the peripheral device proceeds to step 1013 and determines if the expiration of the first timer is notified. If the expiration of the first timer is notified, the peripheral device proceeds to step 1015 and turns Off the wireless communication module, the power supply module. That is, the peripheral device stops an operation of the wireless communication module, and powers off the peripheral device. That is, while the contact is detected in the first sensor, the peripheral device keeps maintaining the waiting state. If the contact is not detected in the first sensor, the peripheral device notifies this to the body. If the expiration of the first timer is notified, the peripheral device returns to the idle state. In contrast, if the expiration of the first tinier is not notified, the peripheral device returns to the step 1009.

If the contact is detected in the first sensor in the step 1009, the peripheral device proceeds to step 1017 and transmits the detection results of the first sensor and the second sensor to the body through the wireless communication module. That is, the peripheral device notifies that the contact is detected in the first sensor. However, if it has not been ever notified that the contact is not detected in the first sensor, the step 1017 may be omitted. Thereafter, the peripheral device proceeds to step 1019 and determines if a contact is detected in the second sensor. If the contact is not detected in the second sensor, the peripheral device returns to the step 1009. In contrast, if the contact is detected in the second sensor, the peripheral device proceeds to step 1021 and transmits the detection results of the first sensor and the second sensor to the body through the wireless communication module. That is, the peripheral device notifies that the contact is detected in the second sensor. Next, the peripheral device proceeds to step 1023 and turns On the photographing module. That is, if the contact is detected in the second sensor while the contact is kept being detected in the first sensor, the peripheral device makes a transition from the waiting state to a measuring state. For this, the peripheral device operates the photographing module. In the measuring state, photographing data generated in the photographing module is transmitted to the body through the wireless communication module.

Next, the peripheral device proceeds to step 1025 and determines if the contact is kept being detected in the second sensor. If the contact is not detected in the second sensor, the peripheral device proceeds to step 1027 and transmits the detection results of the first sensor and the second sensor to the body through the wireless communication module. That is, the peripheral device notifies that the contact is not detected in the second sensor. Thereafter, the peripheral device proceeds to step 1029 and determines if the expiration of a second timer is notified. If the expiration of the second timer is notified, the peripheral device proceeds to step 1031 and turns Off the photographing module. That is, the peripheral device stops an operation of the photographing module. In other words, while the contacts are detected in all of the first sensor and the second sensor, the peripheral device keeps maintaining the measuring state. If the contact in the second sensor is not detected, the peripheral device notifies this to the body. If the expiration of the second timer is notified, the peripheral device stops the operation of the photographing module, thereby making a transition to the waiting state. And, the peripheral device returns to the step 1009.

In contrast, if the expiration of the second timer is not notified, the peripheral device returns to the step 1025. If the contact is detected in the second sensor in the step 1025, the peripheral device proceeds to step 1033 and transmits the detection results of the first sensor and the second sensor to the body through the wireless communication module. That is, the peripheral device notifies that the contact is not detected in the second sensor. However, if it has not been ever notified that the contact is not detected in the second sensor, the step 1033 may be omitted.

According to an exemplary embodiment illustrated in the FIG. 10A and FIG. 10B, in case that the peripheral device is in the measuring state, in other words, in case that the peripheral device performs a circular procedure of the step 1025, the step 1027, the step 1029, step 1033, the peripheral device may firstly make a transition to the waiting state and then, make a transition to the idle state. However, in accordance with another exemplary embodiment of the present invention, the peripheral device may make a transition from the measuring state to the idle state. That is, in case that contacts of all of the first sensor and the second sensor are not detected in the measuring state, the peripheral device may concurrently notify this to the body. Thereafter, according as the expiration of the first timer and the second timer is notified, the peripheral device may make a transition to the idle state, without going through the waiting state.

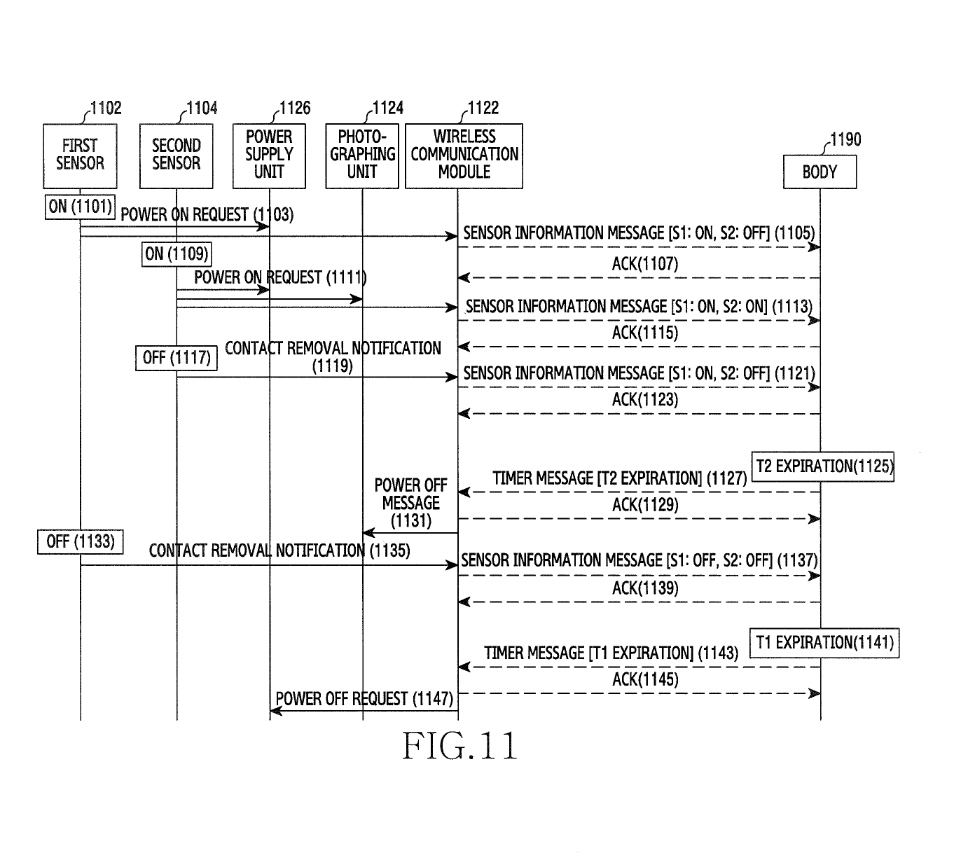

FIG. 11 illustrates a signal exchange of a peripheral device and a body in an electronic device according to an exemplary embodiment of the present invention. The FIG. 11 illustrates a signal exchange for state control as in the FIG. 10A and FIG. 10B.

Referring to the FIG li, in step 1101, a first sensor 1102 detects that a contact occurs at a first point. Here, the contact may be detected through a heat sensor, a motion detection sensor, a pressure sensor, a touch sensor, a contact sensor, a temperature sensor, an electricity sensor and other contact or non-contact determinable sensors. In step 1103, the first sensor 1102 notifies the power supply unit 1126 and the wireless communication module 1122 that the contact occurs at the first point. In step 1105, the wireless communication module 1122 transmits a sensor information message to a body 1190. At this time, the sensor information message informs that the contact exists at the first point, that no contact exists at a second point. In step 1107, the body 1190 transmits an ACK (Acknowledge) informing receiving the sensor information message.

Thereafter, in step 1109, a second sensor 1104 detects that a contact occurs at the second point. In step 1111, the second sensor 1104 notifies the power supply unit 1126, the photographing module 1124, the wireless communication module 1122 that the contact occurs at the second point. In step 1113, the wireless communication module 1122 transmits a sensor information message to the body 1190. At this time, the sensor information message informs that the contact exists at the first point, that the contact exists at the second point. In step 1115, the body 1190 transmits an ACK, informing receiving the sensor information message.

In step 1117, the second sensor 1104 detects that the contact at the second point is removed. In step 1119, the second sensor 1104 notifies the wireless communication module 1122 that the contact at the second point is removed. In step 1121, the wireless communication module 1122 transmits a sensor information message to the body 1190. At this time, the sensor information message informs that the contact exists at the first point, that no contact exists at the second point. In step 1123, the body 1190 transmits an ACK informing receiving the sensor information message.

Thereafter, in step 1125, a second timer (T2) corresponding to the second sensor 1104 expires. In step 1127, the body 1190 transmits a timer message to the wireless communication module 1122. At this time, the timer message informs the expiration of the second timer (T2). In step 1129, the wireless communication module 1122 transmits an ACK informing receiving the timer message. In step 1131, the wireless communication module 1122 requests power Off to the photographing module 1124. At this time, the wireless communication module 1122 may further request power Off to the power supply unit 1126.

In step 1133, the first sensor 1102 detects that the contact at the first point is removed. In step 1135, the first sensor 1102 notifies the wireless communication module 1122 that the contact at the first point is removed. In step 1137, the wireless communication module 1122 transmits a sensor information message to the body 1190. At this time, the sensor information message informs that no contact exists at the first point, that no contact exists at the second point. In step 1139, the body 1190 transmits an ACK informing receiving the sensor information message.

Thereafter, in step 1141, a first tinier (T1) corresponding to the first sensor 1102 expires. In step 1143, the body 1190 transmits a timer message to the wireless communication module 1122. At this time, the timer message informs the expiration of the first timer (T1). In step 1145, the wireless communication module 1122 transmits an ACK informing receiving the timer message. In step 1147, the wireless communication module 1122. requests power Off to the power supply module 1126.

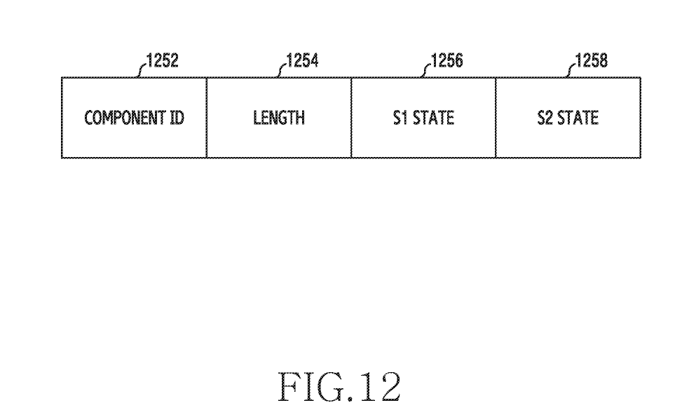

In the exemplary embodiment illustrated in the FIG. 11, the sensor information messages transmitted in the step 1105, the step 1113, the step 1121, the step 1137 may be configured as in FIG. 12 below FIG. 12 illustrates a construction of a sensor related message exchanged between a peripheral device and a body in an electronic device according to an exemplary embodiment of the present invention. Referring to the FIG. 12, the sensor information message includes a component ID 1252, a length 1254, an S1 state 1256, an S2 state 1258. The component ID 1252 includes identification information of the peripheral device transmitting the sensor information message. The length 1254 represents a length of the sensor information message, and the S1 state 1256 represents whether a contact exists in a first sensor, the S2 state 1258 whether a contact exists in a second sensor.

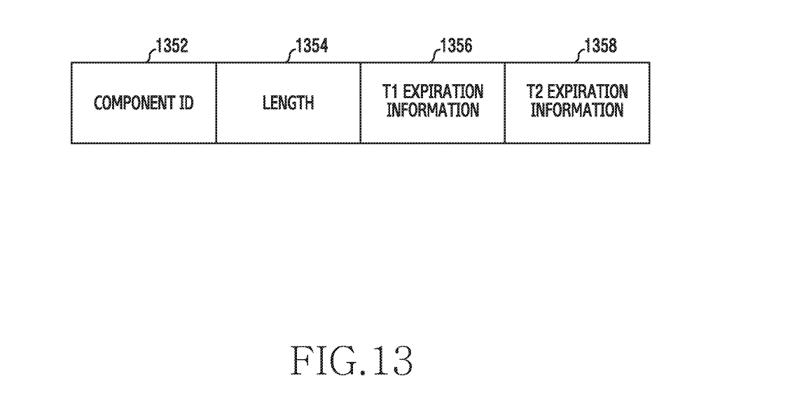

In the exemplary embodiment illustrated in the FIG. 11, the sensor information messages transmitted in the step 1121, the step 1143 may be configured as in FIG. 13 below FIG. 13 illustrates a construction of a timer related message exchanged between a peripheral device and a body in an electronic device according to an exemplary embodiment of the present invention. Referring to the FIG. 13, the timer message includes a component ID 1352, a length 1354, T1 expiration information 1356, T2 expiration information 1358. The component ID 1352 includes identification information of the peripheral device transmitting the timer message. The length 1354 represents a length of the timer message, and the T1 expiration information 1356 represents whether a first timer corresponding to a first sensor expires, the T2 expiration information 1358 whether a second timer corresponding to a second sensor expires.

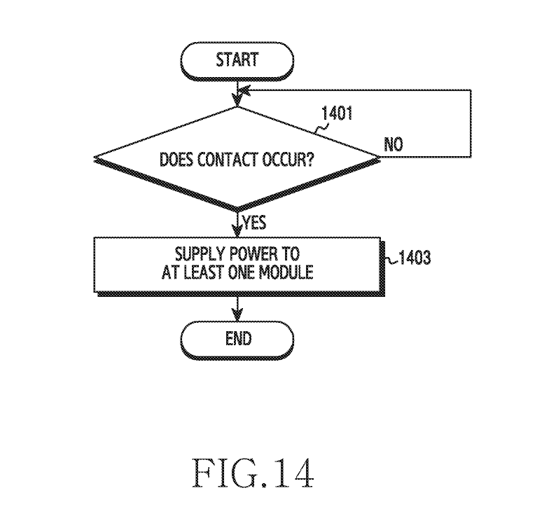

FIG. 14 illustrates an operation procedure of a peripheral device in an electronic device according to an exemplary embodiment of the present invention.

Referring to the FIG. 14, in step 1401, the peripheral device determines if a contact occurs. Here, the contact means a contact with an external object, not the electronic device including the peripheral device. The contact may be detected through at least one sensor installed in a predetermined position. Here, the contact may be detected through a heat sensor, a motion detection sensor, a pressure sensor, a touch sensor, a contact sensor, a temperature sensor, an electricity sensor and other contact or non-contact determinable sensors. The contact may include a contact with a user or a contact with a target related with a use state of the peripheral device.

If the contact occurs, the peripheral device proceeds to step 1403 and supplies power to at least one module among modules included in the peripheral device. For example, in case that the contact occurs in an idle state, the peripheral device turns On a power supply unit supplying power to other modules. Further, the peripheral device may further supply power to a wireless communication module for wireless connection with a body. If the peripheral device supports only the idle state and a measuring state, the peripheral device may supply power to all modules necessary for operation. In contrast, in case that the peripheral device supports three or more states such as an idle state, a waiting state, a measuring state, etc., the peripheral device supplies power to a module corresponding to a current state. In case that the peripheral device supports three or more states, the peripheral device may determine the current state on the basis of at least one of a position of a point at which a contact occurs and the number thereof, That is, the peripheral device may identify a combination of at least one point at which the contact occurs among a plurality of predetermined points so as to detect the contact, and determine a combination of a module to be supplied power in accordance with the identified combination.

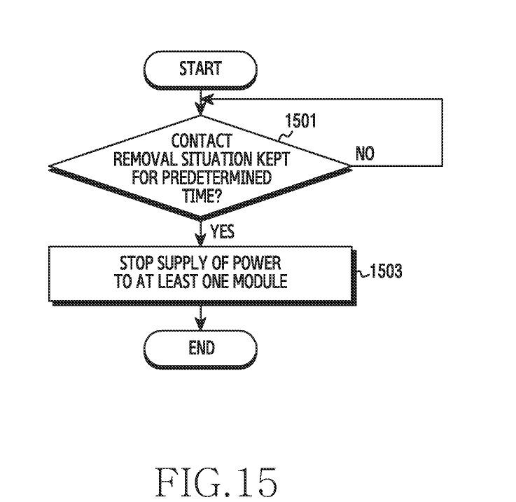

FIG. 15 illustrates an operation procedure of a peripheral device in an electronic device according to another exemplary embodiment of the present invention.

Referring to claim 15, in step 1501, the peripheral device determines if a contact removal situation is maintained for a constant time. Here, the contact may be detected through a heat sensor, a motion detection sensor, a pressure sensor, a touch sensor, a contact sensor, a temperature sensor, an electricity sensor and other contact or non-contact determinable sensors. For example, if a contact is removed at a point at which the contact occurs, the peripheral device may initiate a corresponding timer. If the contact does not again occur until the timer expires, the peripheral device may determine that the contact removal situation has been maintained for a constant time.

If the contact removal situation is maintained for a constant e, the peripheral device proceeds to step 1503 and stops a supply of power to at least one module. Here, the at least one module includes a module corresponding to the point at which the contact is removed. in case that the peripheral device supports only two states such as an idle state and a measuring state, etc., the peripheral device stops a supply of power to all modules, thereby being able to make a transition to the idle state. In contrast, in case that the peripheral device supports three or more states such as an idle state, a waiting state, a measuring state, etc., the peripheral device stops a supply of power to the remaining module except for a module corresponding to a state to which it is to make a transition due to the contact removal. In case that supporting the three or more states, the peripheral device may determine a current state on the basis of at least one of a position of a point at which a contact is maintained and the number thereof.

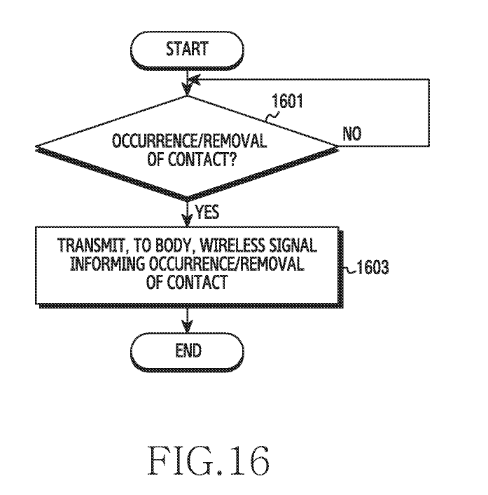

FIG. 16 illustrates an operation procedure of a peripheral device in an electronic device according to a further exemplary embodiment of the present invention.

Referring to FIG the 16, in step 1601, the peripheral device determines if a contact occurs or is removed. Here, the contact means a contact with an external object, not the electronic device including the peripheral device. The occurrence and removal of the contact may be detected through at least one sensor installed in a predetermined position. Here, the contact may be detected through a heat sensor, a motion detection sensor, a pressure sensor, a touch sensor, a contact sensor, a temperature sensor, an electricity sensor and other contact or non-contact determinable sensors. The contact may include a contact with a user or a contact with a target related with a use state of the peripheral device.

If the contact occurs or is removed, the peripheral device proceeds to step 1603 and transmits, to a body, a wireless signal informing the occurrence or removal of the contact. At this time, in case that the peripheral device detects contact or non-contact in a plurality of positions, the wireless signal informs contact or non-contact of each of the plurality of positions. For example, the wireless signal may include information as in the FIG. 12.

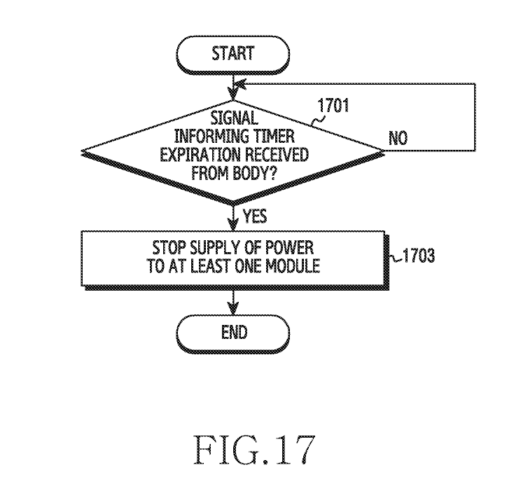

FIG. 17 illustrates an operation procedure of a peripheral device in an electronic device according to a yet another exemplary embodiment of the present invention.

Referring to the FIG. 17, in step 1701, the peripheral device determines if a wireless signal informing the expiration of a timer is received from a body. The timer corresponds to a position detecting contact or non-contact in the peripheral device. Accordingly, in case that the peripheral device detects contact or non-contact in a plurality of positions, the wireless signal informs the expiration or non-expiration of each timer corresponding to each of the plurality of positions. For example, the wireless signal may include information as in the FIG. 13.

If receiving the wireless signal informing the tinier expiration, the peripheral device proceeds to step 1703 and stops a supply of power to at least one module. Here, the at least one module includes a module corresponding to the expiring module. In case that the peripheral device supports only two states such as an idle state and a measuring state, etc., the peripheral device stops a supply of power to all modules, thereby being able to make a transition to the idle state. in contrast, in case that the peripheral device supports three or more states such as an idle state, a waiting state, a measuring state, etc., the peripheral device stops a supply of power to the remaining module except for a module corresponding to a state to which it is to make a transition due to the contact removal. In case that supporting the three or more states, the peripheral device may determine a current state on the basis of at least one of a position of a point at which a contact is maintained and the number thereof.

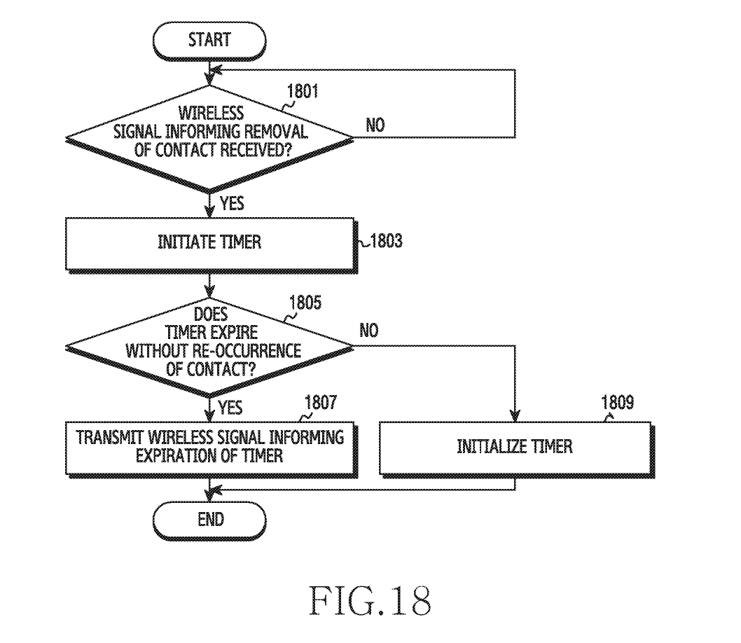

FIG. 18 illustrates an operation procedure of a body in an electronic device according to an exemplary embodiment of the present invention.

Referring to the FIG. 18, in step 1801, the body determines if a wireless signal informing the removal of a contact is received from a peripheral device. At this time, in case that the peripheral device detects contact or non-contact in a plurality of positions, the wireless signal informs contact or non-contact of each of the plurality of positions. For example, the wireless signal may include information as in the FIG. 12.

If the wireless signal informing the removal of the contact is received, the body proceeds to step 1803 and initiates a corresponding timer. That is, the body initiates the counting of a timer value of the timer. The timer corresponds to a position detecting contact or non-contact in the peripheral device. Accordingly, in case that the peripheral device detects contact or non-contact in a plurality of positions, a plurality of timers may exist. That is, in the step 1803, the body may initiate the plurality of timers.

Thereafter, the body proceeds to step 1805 and determines if the timer expires without the re-occurrence of a contact. in other words, the body determines if a time of as much as the timer value lapses without reception of a wireless signal informing the occurrence of the contact. The re-occurrence of the contact may be determined through a wireless signal received from the peripheral device. Here, the re-occurring contact means a contact that occurs in a position in which the contact is removed in the step 1801.

If the timer expires without the re-occurrence of the contact, the body proceeds to step 1807 and transmits, to the peripheral device, a wireless signal informing the expiration of the timer. For example, the wireless signal may include information as in the FIG. 13.

In contrast, if the timer does not expire without the re-occurrence, in other words, if a wireless signal informing the occurrence of a contact is received before the expiration of the timer, the body proceeds to step 1809 and initializes the timer. in other words, the body stops a progress of the timer, and resets a progressed timer value. Accordingly to this, the timer is not again initiated until it is notified that a contact of a point corresponding to the timer is removed.

In the aforementioned various exemplary embodiments of the present invention, stopping a supply of power is determined by the maintenance of a constant time of a contact. At this time, at least one tinier is used to determine the lapse of the constant time. In accordance with an exemplary embodiment of the present invention, a value of the timer may be used as a fixed value. However, in accordance with another exemplary embodiment of the present invention, the value of the timer may be dynamically adjusted according to a situation. For example, the value of the timer may be adjusted according to a battery state of the peripheral device. In a concrete example, as a battery level is less, the timer value may be less. The timer value may be dynamically adjusted according to conditions other than the battery level.

Methods according to exemplary embodiments mentioned in claims and/or specification of the present invention may be implemented in a form of hardware, software, or a combination of the hardware and the software.

If the methods are implemented by the software, a computer-readable storage medium storing one or more programs (software modules) may be provided. The one or more programs stored in the computer-readable storage medium are configured to be executed by one or more processors within an electronic device. The one or more programs may include instructions for enabling the electronic device to execute the methods according to the exemplary embodiments stated in the claims and/or specification of the present invention.

These programs (software modules, software) may be stored in a random access memory, a non-volatile memory including a flash memory, a ROM (Read Only Memory), an EEPROM (Electrically Erasable Programmable Read Only Memory), a magnetic disc storage device, a CD-ROM (Compact Disc-ROM), DVDs (Digital Versatile Discs) or an optical storage device of other form, and a magnetic cassette. Or, they may be stored in a memory constructed by a combination of some or all of them. Also, each constructed memory may be included in plural as well.

Also, the programs may be stored in an attachable storage device accessible through a communication network such as the Internet, an intranet, a LAN (Local Area Network), a WLAN (Wide LAN), or a SAN (Storage Area Network) or a communication network constructed by a combination of them. This storage device may connect to a device performing an exemplary embodiment of the present invention through an external port. Also, a separate storage device on the communication network may connect to a device performing an exemplary embodiment of the present invention.

In the aforementioned concrete exemplary embodiments of the present invention, a constituent element included in the invention has been expressed in the singular number or the plural number in accordance with the proposed concrete exemplary embodiments. But, the expression of the singular number or plural number is selected suitable to a situation proposed for description's convenience, and the present invention is not limited to singular or plural constituent elements. Even the constituent element expressed in the plural number may be constructed in the singular number, or even the constituent element expressed in the singular number may be constructed in the plural number.

While the invention has been shown and described with reference to certain preferred embodiments thereof, it will be understood by those skilled in the art that various changes in form and details may be made therein without departing from the spirit and scope of the invention as defined by the appended claims.

1. A method for operating a peripheral device in an electronic device capable of wirelessly connecting components with each other, the method comprising:
detecting that a contact occurs in at least one predetermined point of the peripheral device; and
supplying power to at least one module located in the peripheral device.

2. The method of claim 1, wherein supplying power to at least one module comprises, to establish a wireless connection with a body through a wireless communication module, supplying power to the wireless communication module.

3. The method of claim 1, wherein supplying power to the at least one module comprises:
identifying the at least one point at which the contact has occurred; and
supplying power to at least one module corresponding to the identified at east one point.

4. The method of claim 1, wherein supplying power to the at least one module comprises:
to detect the contact, identifying a combination of the at least one point at which the contact bias occurred among a plurality of predetermined points; and
determining a combination of a module to be supplied power in accordance with the combination.

5. The method of claim 1, wherein the electronic device is ultrasonic inspection equipment, and
wherein the peripheral device is a probe device.

6. The method of claim 5, wherein supplying power to the at least one module comprises, if the contact has occurred at a point at which a contact with a user is required to use the probe device, supplying power to all modules within the probe device.

7. The method of claim 5, wherein supplying power to the at least one module comprises:
if the contact has occurred at a point at which a contact with a user is required to use the probe device, supplying power to a wireless communication module within the probe device; and
if the contact has occurred at a point at which a contact with a photographing target is required for photographing of the probe device, supplying power to a. photographing module within the probe device,

8. The method of claim 1, further comprising, if the contact of the at least one point has been removed, stopping the supply of power of the at least one module,

9. The method of claim 8, wherein supplying power to the at least one module comprises, if a situation in which the contact has been removed is maintained during a predetermined time, stopping the supply of power.

10. (canceled)

11. A method for operating a body in an electronic device capable of wirelessly connecting components with each other, the method comprising:
receiving, from a peripheral device, a first wireless signal informing that a. contact occurs at a predetermined point of the peripheral device;
receiving a second wireless signal informing that the contact at the point is removed; and
if it is not notified that a contact again occurs at the point until before the expiration of a tinier corresponding to the point after initiating the timer, transmitting, to the peripheral device, a third wireless signal informing the expiration of the timer.

12. The method of claim 11, wherein the electronic device is ultrasonic inspection equipment, and the peripheral device is a probe device.

13. (canceled)

14. An apparatus of a peripheral device in an electronic device capable of wirelessly connecting components with each other, the apparatus comprising:
a sensor configured to detect that a contact occurs in at least one predetermined point of the peripheral device; and
a power supply configured to supply power to at least one module located in the peripheral device.

15. The apparatus of claim 14, wherein the power supply is further configured to supply power to the wireless communication module to establish a wireless connection with a body through a wireless communication module.

16. The apparatus of claim 14, wherein the power supply is further configured to:
identify the at least one predetermined point at which the contact has occurred, and
supply power to at least one module corresponding to the identified at least one predetermined point.

17. The apparatus of claim 14, wherein the power supply is further configured to:
identify a combination of the at least one predetermined point at which the contact has occurred among a plurality of predetermined points to detect the contact, and
determine a combination of a module to be supplied power in accordance with the combination.

18. The apparatus of claim 14,
wherein the electronic device comprises ultrasonic inspection equipment, and
wherein the peripheral device comprises a probe device.

19. The apparatus of claim 18, wherein the power supply is further configured to, if the contact has occurred at a point at which a contact with a user is required to use the probe device, supply power to all modules within the probe device.

20. The apparatus of claim 18, wherein the power supply is further configured to:
if the contact has occurred at a point at which a contact with a user is required to use the probe device, supply power to a wireless communication module within the probe device, and
if the contact has occurred at a point at which a contact with a photographing target is required for photographing of the probe device, supply power to a photographing module within the probe device.

21. The apparatus of claim 14, wherein the power supply is further configured to, if the contact of the at least one predetertnined point has been removed, stop the supply of power of the at least one module.

22. The apparatus of claim 21, wherein the power supply is further configured to, if a situation in which the contact has been removed is maintained during a predetermined time, stop the supply of power.
